(19) United States
(12) Patent Application Publication
(10) Pub. No.: US 2025/0140011 A1
(43) Pub. Date: May 1, 2025

(54) COMMODITY SETTLEMENT PROCESSING METHOD, TERMINAL DEVICE, AND STORAGE MEDIUM

(71) Applicant: PAX COMPUTER TECHNOLOGY (SHENZHEN) CO.,LTD., Shenzhen (CN)

(72) Inventors: QI ZHANG, Shenzhen (CN); XIANGUI ZHANG, Shenzhen (CN); TIANHAO GE, Shenzhen (CN)

(21) Appl. No.: 18/722,613

(22) PCT Filed: Aug. 30, 2022
(86) PCT No.: PCT/CN2022/115886

§ 371 Date: Jun. 21, 2024

(30) Foreign Application Priority Data
Dec. 30, 2021 (CN) 202111669557.0

(51) Int. Cl. G06V 30/413; G06V 10/40; G06V 10/74; G06V 10/764; G06V 10/77; G06V 10/776; G06V 30/414

(52) U.S. Cl. CPC G06V 30/413; G06V 10/40; G06V 10/761; G06V 10/764; G06V 10/7715; G06V 10/776; G06V 30/414

(57) ABSTRACT

A commodity settlement processing method is provided. The method includes obtaining N first images by shooting a settlement area from N shooting angles, the N is a positive integer that is greater than 1. Commodities in each of the N first images are recognized and a preliminary recognition result corresponding to each first image is obtained. Once a final recognition result is determined based on N preliminary recognition results that have been obtained, the commodities in the settlement area are settled according to the final recognition result.

The present application claims a priority to a patent application Ser. No. 202111669557.0 filed with the China National Intellectual Property Administration on Dec. 30, 2021, entire contents of which are incorporated by reference into the present application.

### FIELD

The present application refers to a computer technology field, and in particular, to a commodity settlement processing method, an apparatus, a terminal device and a storage medium.

### BACKGROUND

With a continuous development in a computer vision filed, an image recognition technology is widely used in a retail industry, and a self-service commodity settlement method is gradually being optimized. The self-service commodity settlement method based on the image recognition technology has emerged, that is, a computer uses a deep learning algorithm to process, analyze and understand commodity images to recognize types and a number of commodities.

At present, the self-service commodity settlement is realized through a self-service settlement instrument. When an existing self-service settlement instrument recognizes a plurality of commodities placed in a settlement area, a commodity is often missed for a detection due to a partial or a complete obstruction of the commodity, thereby reducing an accuracy of a commodity recognition and causing an inaccurate commodity settlement.

### BRIEF DESCRIPTION OF THE ACCOMPANYING DRAWINGS

In order to more clearly illustrate the technical solutions in the embodiments of the present application, the drawings required for use in the embodiments or the description of the prior art will be briefly introduced below. Obviously, the drawings described below are only some embodiments of the present application. For ordinary technicians in this field, other drawings can be obtained based on these drawings without paying any creative labor.

FIG. 1 is a flow chart of a commodity settlement processing method provided in an embodiment of the present application;

FIG. 2 is a schematic diagram of specific implementation steps of step 103 in FIG. 1;

FIG. 3 is a schematic diagram of a structure of a commodity settlement processing apparatus provided in an embodiment of the present application;

FIG. 4 is a schematic diagram of a structure of a terminal device provided in an embodiment of the present application.

### EMBODIMENTS OF THE PRESENT APPLICATION

In the following description, specific details such as specific system structures, technologies, etc. are provided for a purpose of illustration rather than a limitation, so as to provide a thorough understanding of embodiments of the present application. However, it should be clear to those skilled in the art that the present application may also be implemented in other embodiments without these specific details. In other cases, detailed descriptions of well-known systems, devices, circuits, and methods are omitted to prevent unnecessary details from obstructing the description of the present application.

It should be understood that when used in the present specification and the appended claims, a term “comprising” indicates a presence of described features, integers, steps, operations, elements and/or components, but does not exclude a presence or an addition of one or more other features, integers, steps, operations, elements, components and/or combinations thereof.

As used in the specification and appended claims of the present application, a term “if” can be interpreted as “when” or “upon” or “in response to determining” or “in response to detecting”, depending on a context. Similarly, a phrase “if it is determined” or “if [a described condition or a described event] is detected” can be interpreted as meaning “upon it is determined” or “in response to determining” or “upon [a described condition or a described event] is detected” or “in response to detecting [a described condition or a described event]”, depending on the context.

In addition, in a description of the present application specification and the appended claims, terms “first”, “second”, “third”, etc. are only used to distinguish descriptions and cannot be understood as indicating or implying relative importance.

References to “one embodiment” or “some embodiments” etc. described in the specification of the present application mean that one or more embodiments of the present application include specific features, structures or characteristics described in conjunction with the embodiment. Therefore, statements “in one embodiment”, “in some embodiments”, “in some other embodiments”, “in other embodiments”, etc. that appear in different places in this specification do not necessarily refer to the same embodiment, but mean “one or more but not all embodiments”, unless otherwise specifically emphasized in other ways. Terms “including”, “comprising”, “having” and their variations all mean “including but not limited to”, unless otherwise specifically emphasized in other ways.

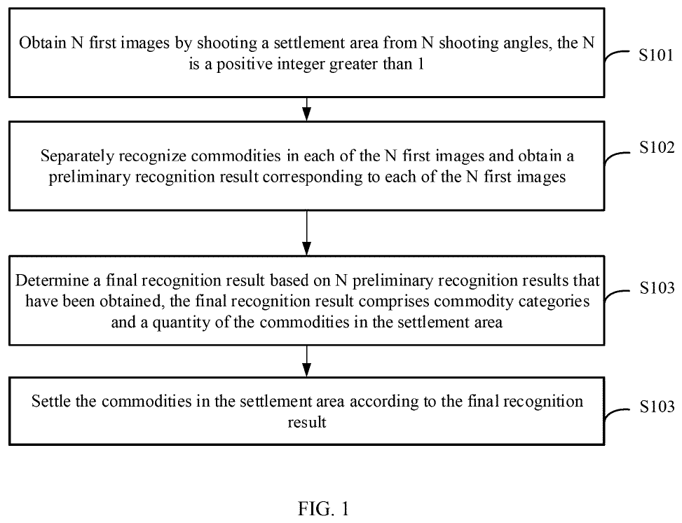

FIG. 1 shows a schematic flow chart of a commodity settlement processing method provided by the present application. With reference to FIG. 1, the commodity settlement processing method is described in detail as follows:
S101, N first images are obtained by shooting a settlement area from N shooting angles, among them, N is a positive integer greater than 1.

Specifically, the settlement area can be photographed from N shooting angles by a camera. Here, there can be one camera, and image collections at different shooting angles can be achieved by moving a shooting position of the camera; there can also be a plurality of cameras, and the plurality of cameras are set at different shooting positions, among them, different shooting positions correspond to different shooting angles, thereby achieving image collections at different shooting angles.
S102, commodities in each first image are recognized separately, and a preliminary recognition result corresponding to each of the N first images is obtained.

Optionally, the preliminary recognition result of the first image includes a commodity category and a similarity of each commodity in the first image.

Here, the similarity of the commodity refers to a similarity of a corresponding commodity category.

It should be noted that a recognition of the commodity in the first image can be achieved through a commodity detection and a feature vector extraction, as described in detail in a first embodiment.
S103, a final recognition result is determined according to N preliminary recognition results that have been obtained, among them, the final recognition result includes commodity categories and a number of the commodities in the settlement area.

It should be noted that since the N first images correspond to images from N shooting angles, if a first commodity is partially or completely blocked within a field of view corresponding to one shooting angle and the first commodity is not recognized. while the first commodity is not blocked within a field of view corresponding to another shooting angle, the first commodity can be recognized. Therefore, the commodities in the N preliminary recognition results recognized by a commodity recognition may be the same or different, but they are all commodities within the settlement area. Therefore, it is necessary to comprehensively consider the N preliminary recognition results to determine the final recognition result, which can improve the accuracy of the commodity recognition.

Here, the final recognition result can be obtained by performing a matching calculation on the N preliminary recognition results, and the details are described in a second embodiment.
S104, the commodities in the settlement area are settled according to the final recognition result.

Specifically, according to the category of the commodity in the final recognition result, a corresponding unit price of the commodity is obtained from a first preset commodity database; based on the category, the unit price and a number of the commodity, an amount to be paid is calculated; and the commodity calculation is completed according to the amount to be paid.

It should be noted that the first preset commodity database is pre-established, and the first preset commodity database includes commodity information of all commodities for sale, among them, the commodity information includes a commodity name, a commodity barcode, a commodity unit price, a commodity weight, and the like.

### First Embodiment

In a possible implementation, the implementation process of step S102 may include:
S1021, a partial image of each commodity in the first image is detected.

Optionally, step S1021 may specifically include:
A1, the first image is input into a first detection model to obtain location information of each commodity in the first image.

Specifically, the location information of the commodity includes location coordinates of the commodity. It should be noted that coordinates of a centroid of a commodity can be calculated based on the location coordinates of the commodity.

It should be noted that the first detection model is a pre-trained detection model, and specific model training steps may include:
1) A data set is collected.

Specifically, multiple commodities are placed in the settlement area at multiple angles without overlap, the settlement area is photographed using cameras at different shooting angles, all commodity categories and location coordinates in the settlement area are marked, and all commodity categories are modified to main commodities.
2) The data set is enhanced and preprocessed.

Specifically, the data set is randomly scaled, randomly color-dithered, and normalized.
3) Model training.

Specifically, a potential commodity detection model is constructed based on a subject detection technology, and a constructed potential commodity detection model is trained using the data set processed in step 2) to obtain a first detection model.
A2, a partial image of each commodity is detected from the first image according to the location information of each commodity.

Specifically, the commodities in the first image are intercepted according to the location coordinates of each commodity to obtain the partial image of each commodity.
S1022, a first feature vector of each partial image in the first image is obtained.

Here, each partial image in the first image may be input into a feature extraction model separately to obtain the first feature vector of each partial image in the first image.

It should be noted that the feature extraction model is a pre-trained model. Specific model training steps may include:
i) A data set is collected.

Specifically, multiple commodities are placed in the settlement area at multiple angles without overlap, the settlement area is photographed using cameras with different shooting angles, and the categories and location coordinates of all commodities in the settlement area are marked; the commodities in the first image are intercepted according to the location coordinates of each commodity, the intercepted images are preprocessed.
ii) The data set is enhanced and preprocessed.

Specifically, the data set is processed by adding gray bars, random color jittering, random scaling, random erasing, and image mixing.
iii) Model training.

Specifically, a commodity feature extraction model is constructed, and the constructed commodity feature extraction model is trained using the data set processed in step ii) to obtain the feature extraction model.
S1023, for each first feature vector, a similarity between the first feature vector and each of second feature vectors in a first preset commodity feature library is calculated, and a target feature vector that has a greatest similarity to the first feature vector is obtained from the second feature vectors.

It should be noted that the first preset commodity feature library is pre-established, and includes feature vectors and commodity categories of all commodities for sale.

In an optional implementation, an index table is established based on all feature vectors in the first preset commodity feature library, each index in the index table corresponds to one second feature vector, and the second feature vector represents feature vectors of a set, and the set includes feature vectors of multiple commodity categories, among them, similarities of feature vectors of the multiple commodity categories are within a preset range, that is, commodities corresponding to the multiple commodity categories are similar commodities; then, a similarity between the first feature vector and the second feature vector of each index is calculated, and one second feature vector having a greatest similarity to the first feature vector in the second feature vectors is obtained, and a target index corresponding to the second feature vector with the greatest similarity to the first feature vector is determined, and a similarity between the first feature vector and each feature vector in the target index is calculated, and a target feature vector having a greatest similarity to the first feature vector in the feature vectors under the target index is obtained. In this way, the first feature vector does not need to be compared one by one with all feature vectors in the first preset commodity feature library, which can improve an calculation efficiency and save a computing power.

The second feature vector represents a set of feature vectors. Specifically, the second feature vector may be a feature vector among all feature vectors in the set, or may be a central feature vector calculated based on all feature vectors in the set.
S1024, the commodity category of the commodity corresponding to the first feature vector is determined as a target commodity category corresponding to the target feature vector, and the similarity of the commodity is determined as a similarity between the target feature vector and the first feature vector.

### Second Embodiment

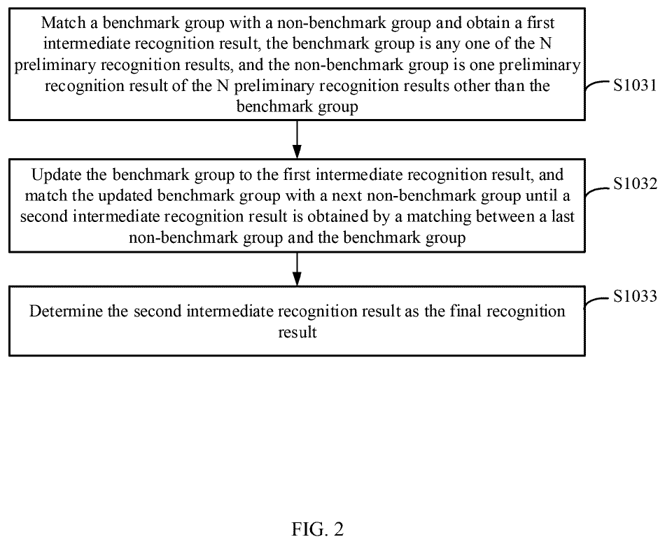

Referring to FIG. 2, in a possible implementation manner, the implementation process of step S103 may include:
S1031, a benchmark group is matched with a non-benchmark group to obtain a first intermediate recognition result, among them, the benchmark group is any one of the N preliminary recognition results, and the non-benchmark group is one preliminary recognition result other than the benchmark group in the N preliminary recognition results.

Optionally, the preliminary recognition result further includes the coordinates of the centroid of each commodity in the first image. That is, each preliminary recognition result includes the commodity category, the similarity and the coordinates of the centroid of each commodity in the first image.

Here, the benchmark group and the non-benchmark group can be matched based on the coordinates of the centroid of the commodity to obtain the first intermediate result. The first intermediate result includes a recognition result determined by a successful matching between the benchmark group and the non-benchmark group and a recognition result determined by an unsuccessful matching between the benchmark group and the non-benchmark group. A specific implementation process can be referred to the description of a third embodiment.
S1032, the benchmark group is updated to the first intermediate recognition result, and the updated benchmark group is matched with a next non-benchmark group, until a second intermediate recognition result is obtained by matching between a last non-benchmark group and the benchmark group.

It should be noted that this step is a cyclic execution process, and a matching process of the updated benchmark group and the next non-benchmark group is similar to the matching process of step S1031, and reference may be made to the description in the third embodiment.
S1033, the second intermediate recognition result is determined as the final recognition result.

Here, the final recognition result includes a number of commodities in the settlement area, the coordinates of the centroid of each commodity, the commodity category of each commodity and the similarity of each commodity.

### Third Embodiment

In a possible implementation manner, the implementation process of step S1031 may include:
B1, a coordinate transformation is performed on the coordinates of the centroid of each commodity in the non-benchmark group to obtain transformed coordinates of each commodity, among them, the transformed coordinates of each commodity in the non-benchmark group and the coordinates of the centroid of each commodity in the benchmark group belong to a same coordinate system.

Here, since the N preliminary recognition results correspond to N first images, and the N first images are images obtained by shooting the settlement area from N shooting angles, the coordinates of the centroid of the commodity in each preliminary recognition result is based on the coordinate system corresponding to each shooting angle. In order to realize a subsequent calculation of a distance value between commodity in different preliminary recognition results, it is necessary to use the coordinate system corresponding to one shooting angle as a basis (a preliminary recognition result corresponding to this shooting angle is the preliminary recognition result of the benchmark group), and the coordinates of the centroid of the commodity in the preliminary recognition result corresponding to other shooting angles are all converted under this coordinate system, thereby realizing a calculation under the same coordinate system.

Specifically, a coordinate mapping relationship matrix is determined according to corresponding camera shooting positions and shooting angles when shooting the N first images, and the coordinate transformation is implemented based on the mapping relationship matrix, among them, the coordinate mapping relationship matrix is used to represent a coordinate mapping relationship between the first images corresponding to the N-1 non-benchmark groups and the first image corresponding to the benchmark group.

For example, N cameras can be set at different positions above the settlement area. Specifically, one camera is set directly above the settlement area, and the first image captured by the camera is a main view. The other N-1 cameras are set around the camera directly above the settlement area and are set at different positions. The first images captured by the N-1 cameras are side views. Then, according to the position and the shooting angle of each camera, the mapping relationship matrix from the side view to the main view can be determined.
B2, a distance value from the transformed coordinates of a jth commodity in the non-benchmark group to the coordinates of the centroid of each commodity in the benchmark group is calculated to obtain a plurality of distance values, among them, j is a positive integer less than or equal to M, and M represents a number of commodities in the non-benchmark group.

It should be noted that a value of j in the jth commodity starts from 1 and goes up to M. In other words, each commodity in the non-benchmark group must execute steps B2 to B3, or steps B2 to B4.
B3, if there is a target distance value among the plurality of distance values, and there is only one target distance value, then a first target value, a second target value and the coordinates of the centroid of the commodity corresponding to the target distance value in the benchmark group are used to generate a commodity matching result, and the commodity matching result is added to the first intermediate recognition result, and the preliminary recognition result of the commodity corresponding to the target distance value is deleted from the benchmark group, among them, the target distance value is a distance value that satisfies a preset threshold range and has a smallest value among the plurality of distance values; the first target value is a maximum similarity between a first result and a second result; the second target value is the commodity category corresponding to the maximum similarity between the first result and the second result; the first result is an initial recognition result of the jth commodity in the non-benchmark group; the second result is an initial recognition result of the commodity corresponding to the target distance value in the benchmark group.

Here, the target distance value is a distance value that satisfies the preset threshold range and has the smallest value among the plurality of distance values, and there is only one target distance value, which means that the jth commodity in the non-benchmark group and a commodity in the benchmark group are within the preset threshold range, that is, their positions overlap within a preset error range, which means that the product in the benchmark group and the jth product in the non-benchmark group are within the preset threshold range and correspond to the same product, that is, the match is successful.

It should be noted that the preliminary recognition result of the commodity corresponding to the target distance value in the benchmark group that is successfully matched is deleted from the benchmark group, of which a purposes is that since the determined commodity matching result has been added to the first intermediate result, a deletion can save a storage space; a second purpose is to improve an efficiency of the matching calculation between the j+1th commodity in a subsequent non-benchmark group and the commodity in the benchmark group, saving the computing power.

It should be noted that when the above-mentioned target distance value exists in the plurality of distance values, but the number of target distance values is more than one, it means that the jth commodity in the non-benchmark group and more than one candidate commodities in the benchmark group are within the preset threshold range, that is, their positions overlap within the preset error range. In other words, it is impossible to determine which one of the candidate commodities the jth commodity corresponds to, and no processing is performed at this time.
B4, if the plurality of distance values are all distance values outside the preset threshold range, then the preliminary recognition result of the jth commodity in the non-benchmark group is added to the first intermediate recognition result;

Here, the plurality of distance values are all distance values outside the preset threshold range, indicating that the distance value between the jth commodity in the non-benchmark group and any commodity in the benchmark group is not within the preset threshold range, that is, there is no position overlap within the preset error range, indicating that the jth commodity in the non-benchmark group is a commodity in the settlement area that is not recognized in the first image corresponding to the benchmark group, so the preliminary recognition result of the jth commodity also needs to be added to the first intermediate recognition result to ensure the accuracy of the commodity recognition.
B5, after each commodity in the non-benchmark group participates in the matching calculation, if there is the preliminary recognition result of a remaining commodity in the benchmark group, the preliminary recognition result of the remaining commodity is added to the first intermediate recognition result.

Here, after each commodity in the non-benchmark group participates in the matching calculation, if there is the preliminary recognition result of the remaining commodity in the benchmark group, it means that there is still commodity in the benchmark group that has not been matched successfully, but it is also the commodity in the settlement area. At this time, the preliminary recognition result of the remaining commodity also need to be added to the first intermediate recognition result to ensure the accuracy of the commodity recognition.

The implementation process of step S103 is described below with an example.

It should be noted that in this example, N cameras are set at different positions above the settlement area. Specifically, one camera is set directly above the settlement area, and the first image taken by the camera is the main view; the other N-1 cameras are set around the camera directly above the settlement area and are set at different positions. The first images taken by the N-1 cameras are side views. The specific commodity matching process is as follows:
1) According to the position and shooting angle of each camera, a mapping relationship matrix from the side view to the main view is determined, and the coordinates of the centroid of each commodity in the commodity recognition result corresponding to the side view are transformed according to the mapping relationship matrix to obtain the transformed coordinates of the centroid.
2) After the transformed coordinates of the commodity in the recognition result corresponding to the side view are obtained, a recognition result corresponding to the main view can be named list0, and a recognition result of one of the side views can be named list1.
3) An empty commodity matching list result_list is initialized to save a current commodity matching result.
4) A recognition result of the first commodity is taken from the list1, and distance values between the coordinates of the centroid of the commodity in the recognition result and the coordinates of the centroids of all commodities in the list0 are calculated.

Specifically, if a distance value between the coordinates of the centroid of a commodity in list0 and the transformed coordinates of the centroid of the first commodity in list1 is within the preset error range and a minimum distance value is unique, then the coordinates of the centroid of the recognition result of a target commodity in list0, and the commodity category and the similarity in the recognition result with a greater similarity between the recognition result of the first commodity in list1 and the recognition result of the target commodity are taken, and the above three values are combined into a commodity matching result, which is added to the result_list, and the recognition result of a target commodity is deleted from the list0, among them, the target commodity is a commodity in the list0 that is associated with a minimum distance value.

If the distance value between the coordinates of the centroid of the commodity in the list0 and the transformed coordinates of the centroid of the first commodity in the list1 is within the preset error range, and the minimum distance value is not unique, no processing is performed.

If the distance values between the coordinates of the centroids of all commodities in the list0 and the coordinates of the centroid of the first commodity in the list1 are all outside the preset error range, the recognition result of the first commodity in the list1 is added to the result_list.
5) Then the recognition result of a second commodity is continued to taken out from the list1, and repeat the above step 4) until the recognition result of each commodity in the list1 completes a matching calculation.
6) If after the recognition result of each commodity in the list1 has completed the matching calculation, the list0 is not empty, then the recognition results of all remaining commodities in the list0 are added to the result_list.

7) The list0 is replaced with the result_list obtained in step 6), the recognition result of a next side view is continued to taken, and it is named as the list1, and then the above step 4) to step 6) are repeated until the recognition result of the commodities in each side view is matched and the final commodity matching result result_list is obtained.

In order to further improve the accuracy of the commodity settlement, in a possible implementation, the implementation process of step S104 may include:

Step S1041, a weight of each commodity in the final recognition result is obtained from the first preset commodity database, and a first commodity total weight is obtained by a calculation.

From the above, it can be seen that the first preset commodity database includes commodity information of each commodity for sale. According to the commodity information of each commodity in the final recognition result in the first preset commodity database, the weight of each commodity is obtained, and the weights of all commodities in the final recognition result are summed up to calculate the first commodity total weight.

Step S1042, a second commodity total weight in the settlement area measured by a weight sensing device is obtained.

It should be noted that the weight sensing device may include a weight sensor and a program for a weight transmission and a calculation. The weight sensor is used to measure a total weight of the commodities in the settlement area, which is recorded as the second commodity total weight.

Step S1043, whether a difference between the first commodity total weight and the second commodity total weight is within a preset error range is determined.

Step S1044, if the difference between the first commodity total weight and the second commodity total weight is within a preset error range, the commodities in the settlement area are settled according to the final recognition result.

Here, the difference between the first commodity total weight and the second commodity total weight is within the preset error range, indicating that a total weight of the commodities calculated by an image recognition is approximately equal to a total weight of the commodities measured by the weight sensing device, which indirectly confirms that the image recognition is accurate.

After step S1043, the above method may further include:

If the difference between the first commodity total weight and the second commodity total weight is outside the preset error range, first prompt information is generated, among them, the first prompt information is used to prompt a customer to place the commodities to be settled in the settlement area again.

Afterwards, if the customer places the commodities to be settled back into the settlement area according to the first prompt information, and a placement time duration exceeds a preset time duration, steps S101 to S104 are repeated.

It can be seen from the above optional embodiments that step S1021, detecting the partial image of each commodity in the first image is implemented through the first detection model, and the commodity category and the location coordinates of the commodity can be detected in the first detection model, and the commodity category that the first detection model can detect is related to the commodity category in the data set of pre-training the model. If the commodity category is not the commodity category corresponding to the first detection model, that is, a newly added commodity category, the first detection model cannot detect the commodity category of the commodity, but can detect the location coordinates of the commodity. If the first detection model is required to detect the newly added commodity category, the first detection model needs to be retrained, which is not only time-consuming, but also has a poor practicality. In order to solve the above problems, in a possible implementation method, the above method of the embodiment of the present application may also include:
S201, basic information of a first commodity of a commodity category that is newly added is obtained, and the basic information is added to a second preset commodity database.

It should be noted that the basic information of the first commodity includes a commodity name, a commodity barcode, a commodity unit price, a commodity specification, a commodity inventory, a commodity weight and other contents of the first commodity.
S202, second images of the first commodity taken from N shooting angles when the first commodity is located at different positions in the settlement area are obtained.

Here, each time the first commodity is located at one position in the settlement area, N second images of the settlement area obtained by shooting the settlement area from N shooting angles are obtained.
S203, when a number of the second images reaches a first preset number, partial images of the first commodity in the first preset number of second images are detected.

Here, making the number of second images reach the first preset number can be achieved by setting the number of times obtaining the second images. For example, if the number of second images does not reach the first preset number, a second prompt information is generated, and the second prompt information is used to prompt a user to adjust a placement position of the first commodity. After that, after the weight sensing device completes a state change, that is, a weight sensing state changes from a stable weight to an unstable weight and then to the stable weight, the second images are obtained by shooting from N shooting angles after the position of the first commodity has been adjusted.

When the number of the second images processed in step S202 reaches a second preset number but does not reach the first preset number, the number of the second images can be increased to the first preset number through a data enhancement.

It should be noted that the first detection model can continue to be used to detect partial images of the first commodity in the first preset number of second images, and there is no need to retrain the detection model. The first detection model only needs to detect the location of the commodity.
S204, a third feature vector of the first preset number of partial images of the first commodity are obtained.

Here, the third feature vector of the first preset number of partial images of the first commodity may be obtained through the feature extraction model.
S205, the commodity category and the third feature vector of the first commodity are added to the second preset commodity feature library.

In this way, through the method in the above implementation, there is no need to conduct a deep learning model training again, which can reduce the difficulty of a commodity entry and greatly reduce a commodity entry time, bringing a convenience to merchants and a high practicality.

It should be understood that a size of sequence numbers of the steps in the above embodiments does not mean an execution order. The execution order of each process should be determined by its function and internal logic, and should not constitute any limitation on the implementation process of the embodiments of the present application.

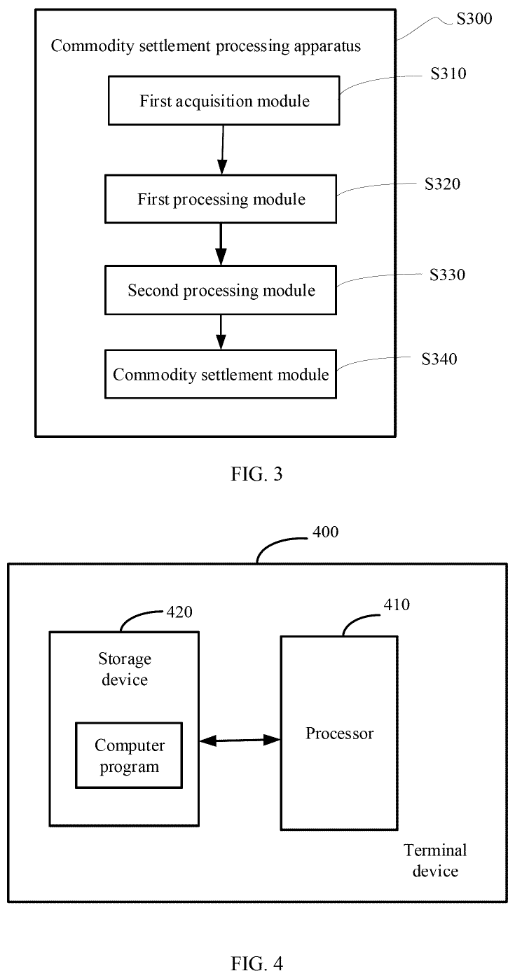

Corresponding to the commodity settlement processing method described in the above embodiment, FIG. 3 shows a structural block diagram of the commodity settlement device provided in the embodiment of the present application. For the sake of convenience of explanation, only the parts related to the embodiment of the present application are shown.

Refer to FIG. 3, an apparatus 300 may include: a first acquisition module 310, a first processing module 320, a second processing module 330, and a commodity settlement module 340.

The first acquisition module 310 is used to acquire N first images by shooting a settlement area from N shooting angles, among them, N is a positive integer greater than 1.

The first processing module 320 is used to recognize commodities in each first image separately, and obtain a preliminary recognition result corresponding to each of the N first images.

The second processing module 330 is used to determine a final recognition result according to the N preliminary recognition results that have been obtained, among them, the final recognition result includes commodity categories and a number of the commodity in the settlement area.

The commodity settlement module 340 is used to settle the commodities in the settlement area according to the final recognition result.

Optionally, the preliminary recognition result of the first image includes the commodity category and the similarity of each commodity in the first image; accordingly, the first processing module 320 may include:

A first detection unit is used to detect a partial image of each commodity in the first image.

A first acquisition unit is used to acquire a first feature vector of each partial image in the first image.

A calculation unit is used to calculate, for each first feature vector, a similarity between the first feature vector and each of second feature vectors in a first preset commodity feature library, and obtain a target feature vector having a greatest similarity to the first feature vector from the second feature vectors.

The first processing unit is used to determine the commodity category of the commodity corresponding to the first feature vector as a target commodity category corresponding to the target feature vector, and determine a similarity of the commodity as a similarity between the target feature vector and the first feature vector.

In an optional implementation, the first detection unit is specifically used for:

Inputting the first image into a first detection model to obtain location information of each commodity in the first image; and a partial image of each commodity is detected from the first image according to the location information of each commodity.

In an optional implementation, the second processing module 330 may include:

A first matching unit is configured to match a benchmark group with a non-benchmark group to obtain a first intermediate recognition result, among them, the benchmark group is any one of the N preliminary recognition results, and the non-benchmark group is one preliminary recognition result other than the benchmark group in the N preliminary recognition results;

A second matching unit is used to update the benchmark group to the first intermediate recognition result, and match the updated benchmark group with a next non-benchmark group until a second intermediate recognition result is obtained by matching between a last non-benchmark group and the benchmark group.

A second processing unit is used to determine the second intermediate recognition result as the final recognition result.

Optionally, the preliminary recognition result further includes the coordinates of the centroid of each commodity in the first image; accordingly, the first matching unit is specifically configured to:

Perform a coordinate transformation on the coordinates of the centroid of each commodity in the non-benchmark group to obtain transformed coordinates of each commodity, among them, the transformed coordinates of each commodity in the non-benchmark group and the coordinates of the centroid of each commodity in the benchmark group belong to a same coordinate system;

Calculate a distance value from the transformed coordinates of a jth commodity in the non-benchmark group to the coordinates of the centroid of each commodity in the benchmark group to obtain a plurality of distance values, among them, j is a positive integer less than or equal to M, and M represents a number of commodities in the non-benchmark group;

If there is a target distance value among the plurality of distance values, and there is only one target distance value, which satisfies a first preset condition, then using a first target value, a second target value and the coordinates of the centroid of the commodity corresponding to the target distance value in the benchmark group to generate a commodity matching result, add the commodity matching result to the first intermediate recognition result, and delete the preliminary recognition result of the commodity corresponding to the target distance value from the benchmark group, among them, the target distance value is a distance value that satisfies a preset threshold range and has a smallest value among the plurality of distance values; the first target value is a maximum similarity between a first result and a second result; the second target value is the commodity category corresponding to the maximum similarity between the first result and the second result; the first result is an initial recognition result of the jth commodity in the non-benchmark group; and the second result is an initial recognition result of the commodity corresponding to the target distance value in the benchmark group.

If the plurality of distance values are all distance values outside the preset threshold range, then the preliminary recognition result of the jth commodity in the non-benchmark group is added to the first intermediate recognition result.

After each commodity in the non-benchmark group participates in the matching calculation, if there is the preliminary recognition result of a remaining commodity in the benchmark group, the preliminary recognition result of the remaining commodity is added to the first intermediate recognition result.

In a possible implementation, the commodity settlement module 340 may be specifically used to:

Obtain a weight of each commodity in the final recognition result from the first preset commodity database, and calculate a first commodity total weight;

Obtain a second commodity total weight in the settlement area measured by a weight sensing device;

Determine whether a difference between the first commodity total weight and the second commodity total weight is within a preset error range;

If the difference between the first commodity total weight and the second commodity total weight is within the preset error range, settle the commodities in the settlement area according to the final recognition result.

In a possible implementation, the device of the embodiment of the present application may further include:

A second acquisition module is used to acquire basic information of a first commodity of a commodity category that is newly added and add the basic information to a second preset commodity database.

A third acquisition module is used to acquire second images of the first commodity taken from N shooting angles when the first commodity is located at different positions in the settlement area.

A detection module is used to detect partial images of the first commodity in the first preset number of second images when the number of the second images reaches a first preset number.

A fourth acquisition module is used to acquire a third feature vector of the first preset number of partial images of the first commodity.

A third processing module is used to add the commodity category and the third feature vector of the first commodity to the second preset commodity feature library.

It should be noted that information interaction, execution process, etc. between the above-mentioned devices/units are based on the same concept as the method embodiment of the present application. Their specific functions and technical effects can be found in the method embodiment part and will not be repeated here.

The skilled in the art can clearly understand that for a convenience and a simplicity of a description, only a division of the above-mentioned functional units and modules is used as an example for illustration. In a practical application, the above-mentioned function allocation can be completed by different functional units and modules as needed, that is, an internal structure of the device can be divided into different functional units or modules to complete all or part of the functions described above. The functional units and modules in the embodiment can be integrated in a processing unit, or each unit can exist physically separately, or two or more units can be integrated in one unit. The above-mentioned integrated unit can be implemented in a form of hardware or in a form of software functional units. In addition, specific names of the functional units and modules are only for the convenience of distinguishing each other, and are not used to limit a scope of protection of the present application. The specific working process of the units and modules in the above-mentioned system can refer to a corresponding process in the aforementioned method embodiment, which will not be repeated here.

The embodiment of the present application also provides a commodity settlement processing system, including a commodity settlement processing apparatus, which is used to implement the steps in any of the above-mentioned method embodiments.

Here, the commodity settlement processing system also includes an image acquisition module, a weight sensing module, a human-computer interaction module, a settlement printing module, a voice playback module and a data storage module.

Among them, the image acquisition module may include one or more cameras and a program for capturing images and preprocessing the images, which collect images of commodities in the settlement area from multiple shooting angles and transmit them to the commodity settlement processing apparatus to prevent an occurrence of situations such as the commodity is obstructed and is missed for an inspection.

The weight sensing module includes a weight sensor and a program for a weight transmission and a calculation, which transmits a weight in the settlement area to the commodity settlement processing apparatus, so as to determine whether a difference between an actual commodity weight for a settlement and a commodity weight obtained by a detection and a matching is within an error range, thereby improving the settlement accuracy.

The human-computer interaction module includes a touch screen device and an automatic checkout application software. A user can use the touch screen device to view a placement of commodities in the settlement area covered by the cameras in an automatic checkout application interface and make various operation selections.

The settlement printing module includes a printer/a POS machine and a program for calculating and printing a settlement list. According to the settlement list transmitted by the commodity settlement processing apparatus, an automatic settlement and operations of printing receipts are completed.

The voice playing module includes a voice player and a program for invoking and playing a voice file. It plays various voice prompts according to instructions of the commodity settlement processing apparatus.

The data storage module includes a storage device and a program for a read/write operation of the storage device, which is used to realize a storage of relevant data such as the first detection model, the feature extraction model, the preset commodity database, the preset commodity feature library, etc., and cooperates with the commodity settlement processing apparatus to complete invoking of data and data storage involved in a settlement process.

The embodiment of the present application also provides a terminal device, as shown in FIG. 4, a terminal device 400 may include: at least one processor 410, a storage device 420, and a computer program stored in the storage device 420 and executable on the at least one processor 410, the processor 410 implements the steps in any of the above-mentioned method embodiments when executing the computer program, such as steps S101 to S104 in the embodiment shown in FIG. 4. Alternatively, the processor 410 implements the functions of each module/unit in the above-mentioned device embodiments when executing the computer program, such as the functions of modules 310 to 340 shown in FIG. 3.

Exemplarily, the computer program may be divided into one or more modules/units, the one or more modules/units are stored in the storage device 420, and executed by the processor 410 to complete the present application. The one or more modules/units may be a series of computer program segments capable of completing specific functions, and the program segments are used to describe the execution process of the computer program in the terminal device 400.

Those skilled in the art may understand that FIG. 4 is merely an example of the terminal device and does not constitute a limitation on the terminal device. The terminal device may include more or fewer components than shown in the figure, or a combination of certain components, or different components, such as input and output devices, network access devices, buses, etc.

The processor 410 may be a central processing unit (CPU), or other general-purpose processors, digital signal processors (DSP), application-specific integrated circuits (ASIC), field-programmable gate arrays (FPGA), or other programmable logic devices, discrete gate or transistor logic devices, discrete hardware components, etc. The general-purpose processor may be a microprocessor or the processor may be any conventional processor, etc.

The storage device 420 may be an internal storage unit of the terminal device, or an external storage device of the terminal device, such as a plug-in hard disk, a smart media card (SMC), a secure digital (SD) card, a flash card, etc. The storage device 420 is used to store the computer program and other programs and data required by the terminal device. The storage device 420 may also be used to temporarily store data that has been output or is to be output.

The bus can be an Industry Standard Architecture (ISA) bus, a Peripheral Component Interconnect (PCI) bus, or an Extended Industry Standard Architecture (EISA) bus, etc. The bus can be an address bus, a data bus, a control bus, etc. For ease of representation, the bus in the drawings of the present application is not limited to only one bus or one type of bus.

Embodiments of the present application can be applied to terminal devices such as computers, tablet computers, laptop computers, netbooks, personal digital assistants (PDAs), etc. The embodiments of the present application does not impose any restrictions on a specific type of terminal devices.

In the above embodiments, the description of each embodiment has its own emphasis. For parts that are not described or recorded in detail in a certain embodiment, reference can be made to the relevant descriptions of other embodiments.

Those of ordinary skill in the art may appreciate that the units and algorithm steps of each example described in conjunction with the embodiments disclosed herein can be implemented in electronic hardware, or a combination of a computer software and electronic hardware. Whether these functions are performed in hardware or software depends on a specific application and design constraints of the technical solution. Professional and technical personnel can use different methods to implement the described functions for each specific application, but such implementation should not be considered to be beyond the scope of the present application.

In the embodiments provided in the present application, it should be understood that the disclosed terminal device, devices and methods can be implemented in other ways. For example, embodiments of the terminal device described above are only schematic. For example, a division of the modules or units is only a division of logical functions. There may be other division methods in actual implementation, such as multiple units or multiple components can be combined or integrated into another system, or some features can be ignored or not executed. Another point is that a mutual coupling or a direct coupling or a communication connection shown or discussed can be an indirect coupling or communication connection through some interfaces, devices or units, which can be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the solution of this embodiment.

In addition, each functional unit in each embodiment of the present application may be integrated into one processing unit, or each unit may exist physically separately, or two or more units may be integrated into one unit. The above-mentioned integrated unit may be implemented in the form of hardware or in the form of software functional units.

If the integrated unit is implemented in the form of a software functional unit and sold or used as an independent product, it can be stored in a computer-readable storage medium. Based on this understanding, the present application implements all or part of the processes in the above-mentioned embodiment method, and can also be completed by instructing the relevant hardware through a computer program. The computer program can be stored in a computer-readable storage medium, and when the computer program is executed by one or more processors, the steps of each of the above-mentioned method embodiments can be implemented.

Similarly, as a computer program product, when the computer program product is run on a terminal device, the steps in the above-mentioned method embodiments can be implemented when the terminal device executes the computer program product.

The computer program includes computer program codes, which may be in a form of source codes, a form of object codes, a form of executable file or some intermediate form, etc. The computer readable medium may include: any entity or device capable of carrying the computer program code, recording medium, USB flash drive, mobile hard disk, magnetic disk, optical disk, computer memory, read-only memory (ROM), random access memory (RAM), electric carrier signal, telecommunication signal and software distribution medium, etc. It should be noted that the content contained in the computer readable medium may be appropriately increased or decreased according to the requirements of legislation and patent practice in the jurisdiction. For example, in some jurisdictions, according to legislation and patent practice, computer readable media do not include electric carrier signals and telecommunication signals.

The embodiments described above are only used to illustrate the technical solutions of the present application, rather than to limit them. Although the present application has been described in detail with reference to the aforementioned embodiments, a skilled in the art should understand that the technical solutions described in the aforementioned embodiments may be modified, or some of the technical features may be replaced by equivalents. Such modifications or replacements do not deviate the essence of the corresponding technical solutions from the spirit and scope of the technical solutions of the embodiments of the present application, and should all be included in the protection scope of the present application.

1. A commodity settlement processing method, comprising:
obtaining N first images by shooting a settlement area from N shooting angles, the N being a positive integer that is greater than 1;
separately recognizing commodities in each of the N first images and obtaining a preliminary recognition result corresponding to each of the N first images;
determining a final recognition result based on N preliminary recognition results that have been obtained, the final recognition result comprising commodity categories and a number of the commodities in the settlement area;
settling the commodities in the settlement area according to the final recognition result.

2. The commodity settlement processing method according to claim 1, wherein the preliminary recognition result of the first image comprises a commodity category and a similarity of each commodity in the first image; and
“separately recognizing commodities in each of the N first images and obtaining a preliminary recognition result corresponding to each of the N first images” comprises:
for each first image, detecting a partial image of each commodity in the first image;
obtaining a first feature vector of each partial image in the first image;
for each first feature vector, calculating a similarity between the first feature vector and each of second feature vectors in a first preset commodity feature library, and obtaining a target feature vector having a greatest similarity to the first feature vector from the second feature vectors;
determining the commodity category of the commodity corresponding to the first feature vector as a target commodity category corresponding to the target feature vector, and determining a similarity of the commodity as a similarity between the target feature vector and the first feature vector.

3. The commodity settlement processing method according to claim 2, wherein “detecting a partial image of each commodity in the first image” comprises:
inputting the first image into a first detection model and obtaining location information of each commodity in the first image;
detecting a partial image of each commodity from the first image according to the location information of each commodity.

4. The commodity settlement processing method according to claim 2, wherein “determining a final recognition result based on N preliminary recognition results that have been obtained” comprises:
matching a benchmark group with a non-benchmark group and obtaining a first intermediate recognition result, wherein the benchmark group is any one of the N preliminary recognition results, and the non-benchmark group is one preliminary recognition result of the N preliminary recognition results other than the benchmark group;
updating the benchmark group to the first intermediate recognition result, and matching the updated benchmark group with a next non-benchmark group until a second intermediate recognition result is obtained by matching between a last non-benchmark group and the benchmark group;
determining the second intermediate recognition result as the final recognition result.

5. The commodity settlement processing method according to claim 4, wherein the preliminary recognition result further comprises coordinates of a centroid of each commodity in the first image;
“matching a benchmark group with a non-benchmark group and obtaining a first intermediate recognition result” comprises:
performing a coordinate transformation on the coordinates of the centroid of each commodity in the non-benchmark group and obtaining transformed coordinates of each commodity, wherein the transformed coordinates of each commodity in the non-benchmark group and the coordinates of the centroid of each commodity in the benchmark group belong to a same coordinate system;
calculating a distance value from the transformed coordinates of a jth commodity in the non-benchmark group to the coordinates of the centroid of each commodity in the benchmark group and obtaining a plurality of distance values, wherein j represents a positive integer less than or equal to M, and M represents a number of commodities in the non-benchmark group;
in response that there is a target distance value among the plurality of distance values, and there is only one target distance value, generating a commodity matching result using a first target value, a second target value and the coordinates of the centroid of the commodity corresponding to the target distance value in the benchmark group, adding the commodity matching result to the first intermediate recognition result, and deleting the preliminary recognition result of the commodity corresponding to the target distance value from the benchmark group, wherein the target distance value is a distance value that satisfies a preset threshold range and has a smallest value among the plurality of distance values; the first target value is a maximum similarity between a first result and a second result; the second target value is the commodity category corresponding to the maximum similarity between the first result and the second result; the first result is an initial recognition result of the jth commodity in the non-benchmark group; the second result is an initial recognition result of the commodity corresponding to the target distance in the benchmark group;
in response that the plurality of distance values are all distance values outside the preset threshold range, adding the preliminary recognition result of the jth commodity in the non-benchmark group to the first intermediate recognition result;
after each commodity in the non-benchmark group participates in a matching calculation, in response that there is the preliminary recognition result of a remaining commodity in the benchmark group, adding the preliminary recognition result of the remaining commodity to the first intermediate recognition result.

6. The commodity settlement processing method according to claim 1, wherein “settling the commodities in the settlement area according to the final recognition result” comprises:
obtaining a weight of each commodity in the final recognition result from a first preset commodity database, and calculating a first commodity total weight;
obtaining a second commodity total weight in the settlement area measured by a weight sensing device;
determining whether a difference between the first commodity total weight and the second commodity total weight is within a preset error range;
in response that the difference between the first commodity total weight and the second commodity total weight is within the preset error range, settling the commodities in the settlement area according to the final recognition result.

7. The commodity settlement processing method according to claim 1, further comprising:
obtaining basic information of a first commodity of a commodity category that is newly added, and adding the basic information to a second preset commodity database;
acquiring second images of the first commodity taken from the N shooting angles when the first commodity is located at different positions in the settlement area;
detecting partial images of the first commodity in a first preset number of the second images in response that a number of the second images reaches the first preset number;
acquiring a third feature vector of the first preset number of partial images of the first commodity;
adding the commodity category of the first commodity and the third feature vector to a second preset commodity feature library.

8-10. (canceled)

11. A terminal device, comprising:
at least one processor; and
a storage device, the storage device storing a computer program, which when executed by the at least one processor, cause the at least one processor to:
obtain N first images by shooting a settlement area from N shooting angles, the N being a positive integer that is greater than 1;
separately recognize commodities in each of the N first images and obtain a preliminary recognition result corresponding to each of the N first images;
determine a final recognition result based on N preliminary recognition results that have been obtained, the final recognition result comprising commodity categories and a number of the commodities in the settlement area;
settle the commodities in the settlement area according to the final recognition result.

12. The terminal device according to claim 11, wherein the preliminary recognition result of the first image comprises a commodity category and a similarity of each commodity in the first image; and
“separately recognize commodities in each of the N first images and obtain a preliminary recognition result corresponding to each of the N first images” comprises:
for each first image, detecting a partial image of each commodity in the first image;
obtaining a first feature vector of each partial image in the first image;
for each first feature vector, calculating a similarity between the first feature vector and each of second feature vectors in a first preset commodity feature library, and obtaining a target feature vector having a greatest similarity to the first feature vector from the second feature vectors;
determining the commodity category of the commodity corresponding to the first feature vector as a target commodity category corresponding to the target feature vector, and determining a similarity of the commodity as a similarity between the target feature vector and the first feature vector.

13. The terminal device according to claim 12, wherein “detect a partial image of each commodity in the first image” comprises:
inputting the first image into a first detection model and obtaining location information of each commodity in the first image;
detecting a partial image of each commodity from the first image according to the location information of each commodity.

14. The terminal device according to claim 12, wherein “determine a final recognition result based on N preliminary recognition results that have been obtained” comprises:
matching a benchmark group with a non-benchmark group and obtaining a first intermediate recognition result, wherein the benchmark group is any one of the N preliminary recognition results, and the non-benchmark group is one preliminary recognition result of the N preliminary recognition results other than the benchmark group;
updating the benchmark group to the first intermediate recognition result, and matching the updated benchmark group with a next non-benchmark group until a second intermediate recognition result is obtained by matching between a last non-benchmark group and the benchmark group;
determining the second intermediate recognition result as the final recognition result.

15. The terminal device according to claim 14, wherein the preliminary recognition result further comprises coordinates of a centroid of each commodity in the first image;
“match a benchmark group with a non-benchmark group and obtain a first intermediate recognition result” comprises:
performing a coordinate transformation on the coordinates of the centroid of each commodity in the non-benchmark group and obtaining transformed coordinates of each commodity, wherein the transformed coordinates of each commodity in the non-benchmark group and the coordinates of the centroid of each commodity in the benchmark group belong to a same coordinate system;
calculating a distance value from the transformed coordinates of a jth commodity in the non-benchmark group to the coordinates of the centroid of each commodity in the benchmark group and obtaining a plurality of distance values, wherein j represents a positive integer less than or equal to M, and M represents a number of commodities in the non-benchmark group;
in response that there is a target distance value among the plurality of distance values, and there is only one target distance value, generating a commodity matching result using a first target value, a second target value and the coordinates of the centroid of the commodity corresponding to the target distance value in the benchmark group, adding the commodity matching result to the first intermediate recognition result, and deleting the preliminary recognition result of the commodity corresponding to the target distance value from the benchmark group, wherein the target distance value is a distance value that satisfies a preset threshold range and has a smallest value among the plurality of distance values; the first target value is a maximum similarity between a first result and a second result; the second target value is the commodity category corresponding to the maximum similarity between the first result and the second result; the first result is an initial recognition result of the jth commodity in the non-benchmark group; the second result is an initial recognition result of the commodity corresponding to the target distance in the benchmark group;
in response that the plurality of distance values are all distance values outside the preset threshold range, adding the preliminary recognition result of the jth commodity in the non-benchmark group to the first intermediate recognition result;
after each commodity in the non-benchmark group participates in a matching calculation, in response that there is the preliminary recognition result of a remaining commodity in the benchmark group, adding the preliminary recognition result of the remaining commodity to the first intermediate recognition result.

16. The terminal device according to claim 11, wherein “settle the commodities in the settlement area according to the final recognition result” comprises:
obtaining a weight of each commodity in the final recognition result from a first preset commodity database, and calculating a first commodity total weight;
obtaining a second commodity total weight in the settlement area measured by a weight sensing device;
determining whether a difference between the first commodity total weight and the second commodity total weight is within a preset error range;
in response that the difference between the first commodity total weight and the second commodity total weight is within the preset error range, settling the commodities in the settlement area according to the final recognition result.

17. The terminal device according to claim 11, wherein the at least one processor is further caused to:
obtain basic information of a first commodity of a commodity category that is newly added, and add the basic information to a second preset commodity database;
acquire second images of the first commodity taken from the N shooting angles when the first commodity is located at different positions in the settlement area;
detect partial images of the first commodity in a first preset number of the second images in response that a number of the second images reaches the first preset number;
acquire a third feature vector of the first preset number of partial images of the first commodity;
add the commodity category of the first commodity and the third feature vector to a second preset commodity feature library.

18. A non-transitory storage medium having a computer program stored thereon, when the computer program is executed by a processor of a terminal device, the processor is caused to perform a commodity settlement processing method, wherein the method comprises:
obtaining N first images by shooting a settlement area from N shooting angles, the N being a positive integer that is greater than 1;
separately recognizing commodities in each of the N first images and obtaining a preliminary recognition result corresponding to each of the N first images;
determining a final recognition result based on N preliminary recognition results that have been obtained, the final recognition result comprising commodity categories and a number of the commodities in the settlement area;
settling the commodities in the settlement area according to the final recognition result.

19. The non-transitory storage medium according to claim 18, wherein the preliminary recognition result of the first image comprises a commodity category and a similarity of each commodity in the first image; and
“separately recognizing commodities in each of the N first images and obtaining a preliminary recognition result corresponding to each of the N first images” comprises:
for each first image, detecting a partial image of each commodity in the first image;
obtaining a first feature vector of each partial image in the first image;
for each first feature vector, calculating a similarity between the first feature vector and each of second feature vectors in a first preset commodity feature library, and obtaining a target feature vector having a greatest similarity to the first feature vector from the second feature vectors;
determining the commodity category of the commodity corresponding to the first feature vector as a target commodity category corresponding to the target feature vector, and determining a similarity of the commodity as a similarity between the target feature vector and the first feature vector.

20. The non-transitory storage medium according to claim 19, wherein “detecting a partial image of each commodity in the first image” comprises:
inputting the first image into a first detection model and obtaining location information of each commodity in the first image;
detecting a partial image of each commodity from the first image according to the location information of each commodity.

21. The non-transitory storage medium according to claim 19, wherein “determining a final recognition result based on N preliminary recognition results that have been obtained” comprises:
matching a benchmark group with a non-benchmark group and obtaining a first intermediate recognition result, wherein the benchmark group is any one of the N preliminary recognition results, and the non-benchmark group is one preliminary recognition result of the N preliminary recognition results other than the benchmark group;
updating the benchmark group to the first intermediate recognition result, and matching the updated benchmark group with a next non-benchmark group until a second intermediate recognition result is obtained by matching between a last non-benchmark group and the benchmark group;
determining the second intermediate recognition result as the final recognition result.

22. The non-transitory storage medium according to claim 21, wherein the preliminary recognition result further comprises coordinates of a centroid of each commodity in the first image;
“matching a benchmark group with a non-benchmark group and obtaining a first intermediate recognition result” comprises:
performing a coordinate transformation on the coordinates of the centroid of each commodity in the non-benchmark group and obtaining transformed coordinates of each commodity, wherein the transformed coordinates of each commodity in the non-benchmark group and the coordinates of the centroid of each commodity in the benchmark group belong to a same coordinate system;
calculating a distance value from the transformed coordinates of a jth commodity in the non-benchmark group to the coordinates of the centroid of each commodity in the benchmark group and obtaining a plurality of distance values, wherein j represents a positive integer less than or equal to M, and M represents a number of commodities in the non-benchmark group;
in response that there is a target distance value among the plurality of distance values, and there is only one target distance value, generating a commodity matching result using a first target value, a second target value and the coordinates of the centroid of the commodity corresponding to the target distance value in the benchmark group, adding the commodity matching result to the first intermediate recognition result, and deleting the preliminary recognition result of the commodity corresponding to the target distance value from the benchmark group, wherein the target distance value is a distance value that satisfies a preset threshold range and has a smallest value among the plurality of distance values; the first target value is a maximum similarity between a first result and a second result; the second target value is the commodity category corresponding to the maximum similarity between the first result and the second result; the first result is an initial recognition result of the jth commodity in the non-benchmark group; the second result is an initial recognition result of the commodity corresponding to the target distance in the benchmark group;
in response that the plurality of distance values are all distance values outside the preset threshold range, adding the preliminary recognition result of the jth commodity in the non-benchmark group to the first intermediate recognition result;
after each commodity in the non-benchmark group participates in a matching calculation, in response that there is the preliminary recognition result of a remaining commodity in the benchmark group, adding the preliminary recognition result of the remaining commodity to the first intermediate recognition result.

23. The non-transitory storage medium according to claim 18, wherein “settling the commodities in the settlement area according to the final recognition result” comprises:
obtaining a weight of each commodity in the final recognition result from a first preset commodity database, and calculating a first commodity total weight;
obtaining a second commodity total weight in the settlement area measured by a weight sensing device;
determining whether a difference between the first commodity total weight and the second commodity total weight is within a preset error range;
in response that the difference between the first commodity total weight and the second commodity total weight is within the preset error range, settling the commodities in the settlement area according to the final recognition result.
